(19) United States
(12) Patent Application Publication
(10) Pub. No.: US 2003/0005856 A1
(43) Pub. Date: Jan. 9, 2003

(54) Ink-Jet ink

(76) Inventors: Yi-Jing Leu, Hsinchu (TW); Yu-Chang Shen, Taipei (TW); In-Shan Sir, Kaohsiung (TW); Chia-Hsin Chien, Taoyuan (TW)

Correspondence Address: RABIN & BERDO, P.C., SUITE 500, 1101 14th STREET, N.W., WASHINGTON, DC, 20005, US

(21) Appl. No.: 10/151,001

(22) Filed: May 21, 2002

(30) Foreign Application Priority Data
May 21, 2001 (TW) 90112164

(51) Int. Cl. C09D 11/02

(52) U.S. Cl. 106/31.67; 106/31.65; 106/31.86

(57) ABSTRACT

An ink-jet ink at least including polyethylene glycol fatty acid ester, colorant, surfactants, and humectant is disclosed. The ink-jet ink effectively reduces the surface tension of the ink jet ink and increases the speed of ink drying. The water fastness of the ink-jet ink of the invention is also improved due to the higher adhesive force between the ink drop and the media.

This application incorporates by reference of Taiwan application Serial No. 90112164, filed May 21, 2001.

### BACKGROUND OF THE INVENTION

1. Field of the Invention

The invention relates in general to an ink-jet ink, and more particularly to an ink-jet ink including polyethylene glycol fatty acid ester.

2. Description of the Related Art

Ink-jet printing technology is well developed and has the advantages of low cost, low noise and being capable of providing full-color prints with ease. Further more, a high-quality printed image can be produced not only on specialty recording media, but also on inexpensive plain papers and transparency films.

Freedom from feathering in the printed image is one of the key requirements of the ink-jet ink. Ink-jet inks with low cohesive force could result in feathering by the aid of capillarity of the paper. Surfactant is therefore usually added to adjust the surface tension and viscosity of the ink and to ensure the image quality.

One weak point of the ink-jet ink is that printed ink is hard to dry since the ink used for ink-jet recording is usually a water base ink. Enhancing the penetration of the ink could result in high speed drying of the ink. Adding agent with high volatility is an alternative way. However, ink added with high-volatility agents could form a crust over the tip of an ink-jet nozzle, which stops the printer from working.

A dye and a pigment are two common colorants. Ink compositions using a dye as the colorant are designed to dry in one second. On the other hand, ink composition using a pigment as the colorant normally takes more time to dry since the particles of the pigments are larger.

Ink compositions using a dye as the colorant provides high vividness but low light fastness. Dye ink has better water solubility but less water fastness. It is because when a printed image using a dye ink contacts with water, the dye redissolves in the water. Organic compound or resin is often added to overcome the weak point by enhancing the adhesive force to the colorant and media.

### SUMMARY OF THE INVENTION

It is therefore an object of the invention to propose an ink-jet ink providing low surface tension, fast drying, higher adhesive force between the ink drops and the media in order to improve the water fastness of the printed image.

The invention achieves the above-identified objects by providing a composition of an ink-jet ink, which comprises: polyethylene glycol fatty acid ester, a pigment and a solvent. Polyethylene glycol fatty acid ester is selected from the group consisting of polyethylene glycol mono-oleate(PEGMO), polyethylene glycol di-oleate(PEGDO), polyethylene glycol mono-stearate(PEGMS), polyethylene glycol di-stearate(PEGDS), polyethene glycol mono-laurate(PEGML), polyethene glycol di-laurate(PEGDL), polyethylene glycol mono-tallate(PEGMT), and polyethylene glycol di-tallate(PEGDT). The amount of said polyethylene glycol fatty acid ester is about 0.01 wt %˜15.0 wt % and the molecular weight of polyethylene glycol of said polyethylene glycol fatty acid ester is less than 1500. The pigment is a disperse pigment, the particle size of the disperse pigment is in the range between 0.001 μm and 1.0 μm and the amount of the disperse pigment is in the range between 1.0 wt % and 5.0 wt %. The solvent of the ink is an aqueous solvent such as water and the amount thereof is in the range between 70.0 wt % and 90.0 wt %. The ink-jet ink can further comprises aqueous organic solvent, inorganic salt, a surfactant, a humectant, which is a water-soluble organic compounds with low volatility such as ethylene glycol, polyethylene glycol or glycerol, biocide, buffer and other addatives.

Other objects, features, and advantages of the invention will become apparent from the following detailed description of the preferred but non-limiting embodiments.

### DETAILED DESCRIPTION OF THE INVENTION

An ink-jet ink according to a preferred embodiment of the invention at least includes: polyethylene glycol fatty acid ester and colorant, which are all solved in an aqueous solvent. Preferably, surfactant, humectant or biocide is added in the ink-jet ink of the invention.

Polyethylene glycol fatty acid ester added in the ink-jet ink is preferably in the range between 0.01 wt % and 15.0 wt %. Polyethylene glycol fatty acid ester can be any one or any combination of the following: polyethylene glycol mono-oleate (PEGMO), polyethylene glycol di-oleate (PEGDO) polyethylene glycol mono-stearate (PEGMS), polyethylene glycol di-stearate (PEGDS), polyethene glycol mono-laurate (PEGML) polyethene glycol di-laurate (PEGDL), polyethylene glycol mono-tallate (PEGMT) and polyethylene glycol di-tallate (PEGDT). The molecular weight of polyethylene glycol (PEG) is preferably less than 1500. PEG400DO, PEGDO with PEG having a molecular weight of 400, is an example of preferred polyethylene glycol fatty acid ester.

Polyethylene glycol fatty acid ester effectively reduces the surface tension of the ink that uses pigments as a colorant so that the ink is able to dry fast. Moreover, polyethylene glycol fatty acid ester enhances the adhesion of the pigments to the media, provides better water fastness and rub fastness.

Small particle disperse pigments with sizes between about 0.001 μm and 1.0 μm are preferred. The amount of the pigments can be between about 1.0 wt % and 10.0 wt % and preferably between 1.0 wt % and 5.0 wt %. Pigments enhances the water fastness and light fastness of the ink but it is better to be applied together with a dispersing agent and an adhesion agent to prevent precipitate and the consequential blockage of the nozzle.

The aqueous solvent of the ink according to a preferred embodiment of the invention can be water, in the amount of 50.0 wt %˜95.0 wt %, preferably in the amount of 70.0 wt %˜90.0 wt %. In addition, other solvent like organic solvent and inorganic salt can be also applied to enhance the penetration and dispersion of the ink.

One or more than one surfactants can be added to adjust the viscosity for smooth ink supply and ink-jet and to adjust the surface tension of the ink to prevent feathering. Moreover, surfactants also enhance the penetration and dispersion of the ink. Surfactants applied in the ink of the invention can be anionic, nonionic, cationic or amphoteric surfactants. The total amount of the surfactant is less than 15.0 wt %, preferably 0.1 wt %˜10.0 wt %.

To prevent the clogging of the nozzle, humectants can be added because humectants slow down the speed of ink evaporation. Humectants can be water-soluble organic compounds with low volatility such as ethylene glycol, polyethylene glycol, and glycerol. The amount thereof is less than 10.0 wt %, preferably in the range between 0.1 wt % to 10.0 wt %.

Biocide is one of the preferred additives. Biocide inhibits the growing of the bacteria. Buffer is another preferred additive. Buffer keeps the ink in a range of suitable pH value to express ideal colors.

It is well known to persons skilled in the art that other additives which enhance light fastness or the stability in storage can also be added in the ink of the invention.

Recipes of the ink-jet ink of the invention are taken as examples and are listed as follows.

### EXAMPLE 1

The ink-jet ink of the invention includes at least the following:

| | |
|---|---|
| disperse pigments | 7.0 wt % |
| nonionic surfactants | 9.0 wt % |
| humectants | 7.5 wt % |
| water-soluble organic solvent | 4.0 wt % |
| polyethylene glycol fatty acid ester | 6.5 wt % |
| biocide | 0.5% |
| deionized water | for balancing |

Polyethylene glycol fatty acid ester can be any one or any combination of the followings: PEGMO•PEGDO•PEGMS•PEGDS•PEGMT•PEGDT•PEGML and PEGDL. The molecular weight of the polyethylene glycol is preferably less than 1500. In Table I, different receipts of ink-jet ink of the invention are shown. The Ink-jet ink 1 is a control. Polyethylene glycol fatty acid ester is not added in the control.

The ink drying test is done by covering a blank plain paper on a printed image immediately after it is printed in order to absorb the ink. The more ink is transferred to the test plain paper, the slower the drying speed of the ink is. The results are qualitatively differentiated as superior, good, acceptable and inferior.

Water fastness of the ink is tested by spraying a determined quantity of water on a printed image immediately after it is printed. After a determined period of time, the degree of feathering is observed. The results are qualitatively differentiated as superior, good, acceptable and inferior.

TABLE 1

| | Polyethylene | | | |
|---|---|---|---|---|
| | Glycol Fatty | Surface | | |
| Ink Jet | Acid Ester | Tension | | Water |
| Ink | (amount wt %) | (dyne/cm) | Drying Test | Fastness |
| 1 | None | 58.7 | Inferior | Inferior |
| 2 | PEG200MO(6.5%) | 33.7 | Good | Acceptable |
| 3 | PEG400MO(6.5%) | 35.0 | Good | Acceptable |
| 4 | PEG600MO(6.5%) | 35.7 | Good | Acceptable |
| 5 | PEG600DO(6.5%) | 31.4 | Superior | Good |
| 6 | PEG600MS(6.5%) | 35.3 | Good | Acceptable |
| 7 | PEG600MT(6.5%) | 35.6 | Good | Acceptable |
| 8 | PEG600ML(6.5%) | 35.5 | Good | Acceptable |
| 9 | PEG400DO(3%) + | 31.0 | Superior | Superior |
| | PEG600DO(3.5%) | | | |
| 10 | PEG400DO(3%) + | 33.2 | Good | Good |
| | PEG400MO(3.5%) | | | |
| 11 | PEG200MO(1.5%) + | 34.9 | Good | Acceptable |
| | PEG400MO(2%) | | | |
| | PEG600MO(3%) + | | | |
| 12 | PEG200MO(2%) + | 33.5 | Good | Good |
| | PEG400DO(2%) + | | | |
| | PEG600ML(2.5%) | | | |

It is therefore apparent that the ink-jet ink with one or more than one polyethylene glycol fatty acid ester effectively reduces the surface tension of the ink jet ink and increases the speed of ink drying. The water fastness of the ink-jet ink of the invention is also improved due to the higher adhesive force between the ink drop and the media.

While the invention has been described by way of examples and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An ink-jet ink comprising:
polyethylene glycol fatty acid ester;
a pigment; and
a solvent.

2. The ink-jet ink of claim 1, wherein said polyethylene glycol fatty acid ester is selected from the group consisting of polyethylene glycol mono-oleate(PEGMO), polyethylene glycol di-oleate(PEGDO), polyethylene glycol mono-stearate(PEGMS), polyethylene glycol di-stearate(PEGDS), polyethene glycol mono-laurate(PEGML), polyethene glycol di-laurate(PEGDL), polyethylene glycol mono-tallate(PEGMT), and polyethylene glycol di-tallate(PEGDT).

3. The ink-jet ink of claim 1, wherein an amount of said polyethylene glycol fatty acid ester is about 0.01 wt %˜15.0 wt %.

4. The ink-jet ink of claim 1, wherein a molecular weight of polyethylene glycol of said polyethylene glycol fatty acid ester is less than 1500.

5. The ink-jet ink of claim 1, wherein the pigment is a disperse pigment.

6. The in jet ink of claim 5, wherein a particle size of the disperse pigment is in the range between 0.001 μm and 1.0 μm.

7. The ink-jet ink of claim 5, wherein an amount of the disperse pigment is in the range between 1.0 wt % and 10.0 wt %.

8. The ink-jet ink of claim 7, wherein the amount of the disperse pigment is in the range between 1.0 wt % and 5.0 wt %.

9. The ink-jet ink of claim 5 further comprising a dispersing agent and an adhesion agent.

10. The ink-jet ink of claim 1, wherein the solvent is an aqueous solvent.

11. The ink-jet ink of claim 10, wherein the aqueous solvent is water.

12. The ink-jet ink of claim 10, wherein an amount of the aqueous solvent is in the range between 50.0 wt % and 95.0 wt %.

13. The ink-jet ink of claim 12, wherein the amount of the aqueous solvent is in the range between 70.0 wt % and 90.0 wt %.

14. The ink-jet ink of claim 10 further comprising aqueous organic solvent and inorganic salt.

15. The ink-jet ink of claim 1 furthering comprising a surfactant.

16. The ink-jet ink of claim 15, wherein an amount of the surfactant is in the range between about 0.1 wt % and 10.0 wt %.

17. The ink-jet ink of claim 1 further comprising a humectant.

18. The ink-jet ink of claim 17, wherein the humectant is a water-soluble organic compounds with low volatility.

19. The ink-jet ink of claim 17, wherein the water-soluble organic compounds with low volatility is ethylene glycol.

20. The ink-jet ink of claim 18, wherein the water-soluble organic compounds with low volatility is polyethylene glycol.

21. The ink-jet ink of claim 18, wherein the water-soluble organic compounds with low volatility is glycerol.

22. The ink-jet ink of claim 17, wherein an amount of the humectant is in the range between about 0.1 wt % and 10.0 wt %.

23. The ink-jet ink of claim 1 further comprising biocide.

24. The ink-jet ink of claim 1 further comprising buffer.

25. The ink-jet ink of claim 1 further comprising additives which enhance light fastness or the stability in storage.
